(19) United States
(12) Patent Application Publication
(10) Pub. No.: US 2026/0032052 A1
(43) Pub. Date: Jan. 29, 2026

(54) SYSTEM AND METHOD FOR PROGRAMMATIC ROUTE LEAKING WITH RESOURCE SHARING

(71) Applicant: Alkira, Inc., San Jose, CA (US)

(72) Inventors: Ramakanth Gunuganti, San Jose, CA (US); Arjun Sreekantiah, San Jose, CA (US); Sripathy Ramaswamy, Milpitas, CA (US); Shaival Rajan Shah, Durham, NC (US)

(21) Appl. No.: 19/281,234

(22) Filed: Jul. 25, 2025

Related U.S. Application Data
(60) Provisional application No. 63/676,279, filed on Jul. 26, 2024.

(51) Int. Cl. H04L 41/0896; H04L 45/00

(52) U.S. Cl. CPC H04L 41/0896; H04L 45/54

(57) ABSTRACT

Disclosed is a system and a method for managing communication between isolated network segments. The system comprising one or more hardware processors, and a memory storing instructions that, when executed by the one or more hardware processors, cause the system to receive definitions of a first segment resource associated with a first network segment and a second segment resource associated with a second network segment such that each of the first and second segment resources comprises connectors and associated subnets or routes, generate a segment resource-share policy specifying one or more subnets or routes associated with the first segment resource to be leaked into the second network segment, or one or more subnets or routes associated with the second segment resource to be leaked into the first network segment, and distribute the segment resource-share policy in a form accessible to one or more network nodes configured to enforce the policy.

### CROSS-REFERENCE TO RELATED APPLICATION

This application claims the benefit of priority to U.S. Provisional Patent Application No. 63/676,279 entitled “A System and Method for Programmatic Route Leaking with Resource Sharing” filed on Jul. 26, 2024 which is incorporated herein by reference.

### TECHNOLOGICAL FIELD

The present disclosure generally relates to computer networks and cloud computing systems, and more particularly, relates to systems and methods for managing network connectivity and routing between distributed computing resources across cloud and on-premise environments.

### BACKGROUND

Enterprise and cloud networking environments frequently utilize network segmentation to isolate users, applications, or services based on security requirements, organizational roles, or functional domains. This network segmentation helps enforce access controls, streamline traffic management, and meet compliance goals. However, isolation caused by the network segmentation can pose challenges when multiple segments need to access shared services, such as authentication systems, cloud-hosted applications, or centralized resources. The inability to route traffic between isolated segments prevents seamless connectivity and can complicate service delivery across the organization.

### SUMMARY

The present disclosure provides a system and method to facilitate controlled connectivity between isolated network segments in a computing environment, such as cloud, hybrid-cloud, or enterprise networks. More particularly, the present disclosure addresses the challenge of allowing communication between workloads or users in different segments when access to specific resources is required, without compromising the isolation boundaries established for operational, security, or administrative reasons.

In multi-segmented network architectures, different user groups or workloads are placed into distinct segments that are not allowed to communicate with each other by default. However, there are scenarios where a workload or service in one segment (such as an application or shared infrastructure component) needs to be accessed by users or processes in another segment. The present disclosure solves this problem by introducing a policy-driven mechanism that defines segment resources comprising connectors and their associated subnets or routes, and binds them using a segment resource-share policy. This segment resource-share policy governs which routes should be programmatically leaked between segments to enable access to specific resources. The segment resource-share policy is distributed via a centralized controller to a cloud exchange platform (CXP), where node services apply the policy by injecting the appropriate routes into the forwarding plane using serialization techniques. This enables bi-directional or uni-directional access to shared services while maintaining segment isolation for all other traffic. Optional security policies may also be enforced by redirecting shared traffic through firewalls for inspection.

The present disclosure enables scalable and dynamic inter-segment connectivity through software-defined abstractions and route-leak enforcement at the source, eliminating the need for static configuration across the entire network and supporting fine-grained access control.

In an embodiment, the present disclosure discloses a system for managing communication between isolated network segments. The system may comprise one or more hardware processors, and a memory storing instructions that, when executed by the one or more hardware processors, may cause the system to receive definitions of a first segment resource associated with a first network segment and a second segment resource associated with a second network segment, wherein each of the first segment resource and the second segment resource comprises one or more connectors and associated subnets or routes, and wherein the first network segment is isolated from the second network segment. The system may further generate a segment resource-share policy specifying one or more subnets or routes associated with the first segment resource to be leaked into the second network segment, or one or more subnets or routes associated with the second segment resource to be leaked into the first network segment. The system may further store or distribute the segment resource-share policy in a form accessible to one or more network nodes configured to enforce the segment resource-share policy.

In accordance with an additional system embodiment, the segment resource-share policy may define a bidirectional route leakage between the first segment resource and the second segment resource. Additionally, or alternatively, the segment resource-share policy may also define a unidirectional route leakage from the first segment resource to the second network segment.

In accordance with an additional system embodiment, generating the segment resource-share policy may comprise generating a separate policy fragment for each connector included in the first segment resource and the second segment resource.

In accordance with an additional system embodiment, the segment resource-share policy may be stored in a database in a serialized format accessible to the one or more network nodes.

In accordance with an additional system embodiment, each network node of the one or more network nodes may extract routing information from a routing protocol stack and apply the segment resource-share policy to inject the one or more subnets or routes associated with the first segment resource into a routing table associated with the second network segment, or the one or more subnets or routes associated with the second segment resource into a routing table associated with the first network segment.

In accordance with an additional system embodiment, the system may tag one or more routes defined by the segment resource-share policy for policy-based forwarding or redirection.

In accordance with an additional system embodiment, the one or more routes defined by the segment resource-share policy may be redirected through a firewall for application of a security policy.

In accordance with an additional system embodiment, the system may receive, via a user interface or application programming interface, input from a user or application defining the segment resource-share policy, and generate the segment resource-share policy based on the received input.

In accordance with an additional system embodiment, the system may comprise a user interface such that the system may receive an input via the user interface to permit the first network segment to access a cloud workload in the second network segment.

In accordance with an additional system embodiment, the system may redirect traffic flow originating from the first network segment destined to a cloud workload hosted in the second network segment through a firewall.

In another aspect, the present disclosure also provides a method for managing communication between isolated network segments. The method may comprise receiving definitions of a first segment resource associated with a first network segment and a second segment resource associated with a second network segment, wherein each of the first segment resource and the second segment resource comprises one or more connectors and associated subnets or routes, and wherein the first network segment is isolated from the second network segment. The method may further comprise generating a segment resource-share policy specifying one or more subnets or routes associated with the first segment resource to be leaked into the second network segment, or one or more subnets or routes associated with the second segment resource to be leaked into the first network segment. The method may further comprise storing or distributing the segment resource-share policy in a form accessible to one or more network nodes configured to enforce the segment resource-share policy.

In accordance with an additional method embodiment, the segment resource-share policy may define a bidirectional route leakage between the first segment resource and the second segment resource.

In accordance with an additional method embodiment, the segment resource-share policy may define a unidirectional route leakage from the first segment resource to the second network segment.

In accordance with an additional method embodiment, generating the segment resource-share policy may comprise generating a separate policy fragment for each connector included in the first segment resource and the second segment resource.

In accordance with an additional method embodiment, the segment resource-share policy may be stored in a database in a serialized format accessible to the one or more network nodes.

In accordance with an additional method embodiment, each network node of the one or more network nodes may be configured to extract routing information from a routing protocol stack and apply the segment resource-share policy to inject the one or more subnets or routes associated with the first segment resource into a routing table associated with the second network segment, or the one or more subnets or routes associated with the second segment resource into a routing table associated with the first network segment.

In accordance with an additional method embodiment, the method may also comprise tagging one or more routes defined by the segment resource-share policy for policy-based forwarding or redirection.

In accordance with an additional method embodiment, the one or more routes defined by the segment resource-share policy may be redirected through a firewall for application of a security policy.

In another aspect, the present disclosure also provides a non-transitory computer-readable medium having stored thereon computer-executable instructions, which when executed by one or more processors, cause the one or more processors to execute operations. The operations may comprise receiving definitions of a first segment resource associated with a first network segment and a second segment resource associated with a second network segment, wherein each of the first segment resource and the second segment resource comprises one or more connectors and associated subnets or routes, and wherein the first network segment is isolated from the second network segment. The operations may further comprise generating a segment resource-share policy specifying one or more subnets or routes associated with the first segment resource to be leaked into the second network segment, or one or more subnets or routes associated with the second segment resource to be leaked into the first network segment. The operation may also comprise storing or distributing the segment resource-share policy in a form accessible to one or more network nodes configured to enforce the segment resource-share policy.

### BRIEF DESCRIPTION OF THE DRAWINGS

FIG. 1A is a diagram of an example of a cloud services exchange (CSX) in accordance with an embodiment of the disclosure.

FIG. 1B is a diagram of an example of a CSX in accordance with an embodiment of the disclosure.

FIG. 2 is a diagram of an example of a cloud exchange point (CXP) in accordance with an embodiment of the disclosure.

FIG. 3 is a diagram of an example of route leak provisioning in a CSX, in accordance with an embodiment of the disclosure.

FIG. 4 is a flowchart of an example of a method for route leak provisioning, in accordance with an embodiment of the disclosure.

### DETAILED DESCRIPTION

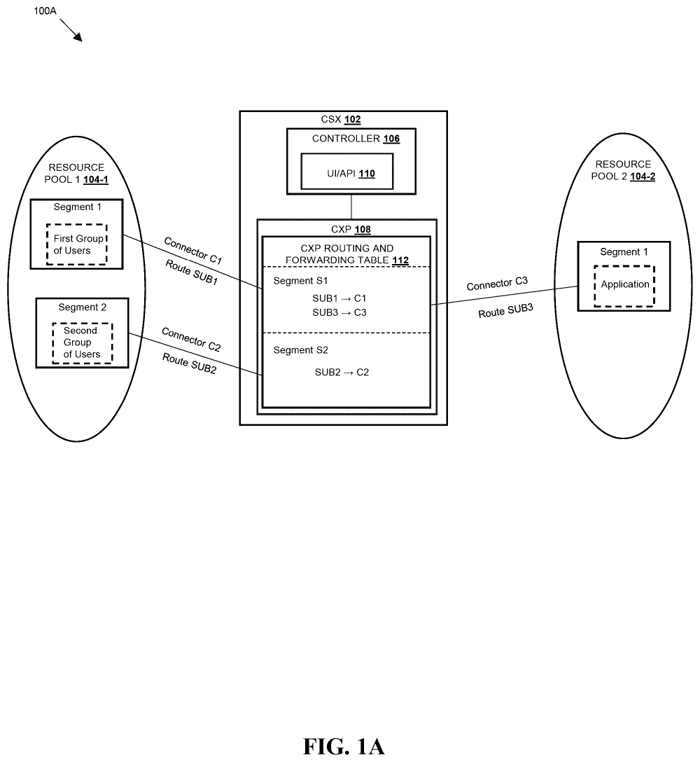

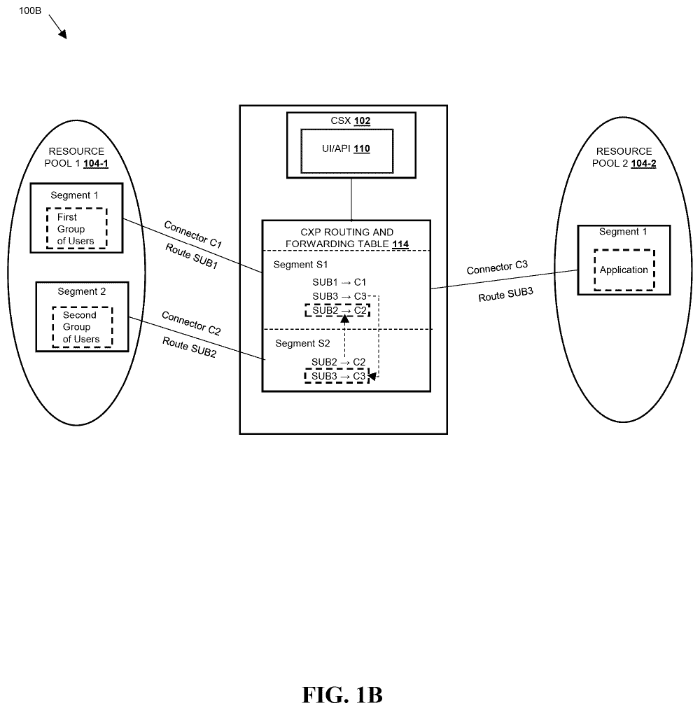

FIG. 1A is a diagram 100A of an example of a cloud services exchange (CSX). The diagram 100A includes a CSX 102, a resource pool 104-1, and a resource pool 104-2. In the diagram 100A, the CSX 102 includes at least a controller 106 and a cloud exchange point (CXP) 108. In the diagram 100A, the controller 106 includes at least a user interface or application programming interface (UI/API) 110.

The CSX 102 is a multi-cloud network to unify or interconnect multiple cloud resources such as, but not limited to, the resource pool 104-1 and the resource pool 104-2. The CSX 102 enables network connectivity from on-premises to clouds including, but not limited to, Amazon Web Services (AWS), Google Cloud Platform (GCP) and Microsoft Azure. The CSX 102 provides for cloud-to-cloud connectivity within and across regions, and regionalized cloud to Internet or software as a service (SaaS) connectivity. Additionally, the CSX 102 may also provide for granular billing for multi-cloud network and services for better financial management and control.

The resource pool 104-1 and the resource pool 104-2 may indicate cloud or on-premise resources as being associated with different cloud or on-premise networks or environments. As an example, the resource pool 104-1 may include one or more cloud workloads connected to one or more cloud workloads of the resource pool 104-2. A cloud workload is a computational task, process or data transaction. Cloud workloads may encompass computing power, memory, storage and network resources required for the execution and management of applications and data. Within the cloud framework, a workload is a service, function or application that uses computing power hosted on cloud servers. The cloud workloads may rely on technologies such as, but not limited to, virtual machines (VMs), containers, serverless, microservices, storage buckets, SaaS, or infrastructure as a service (IaaS).

In an example, the resource pool 104-1 or 104-2 may be divided into segments to isolate a first set of cloud workloads from a second set of cloud workloads. In an example, the first set of cloud workloads may be associated with a first group of users of an enterprise company and the second set of cloud workloads may be associated with a second group of users of the same or different enterprise company. As an example, the resource pool 104-2 may include one or cloud workloads such as, but not limited to, SaaS applications being hosted by one of the segments in the resource pool 104-1.

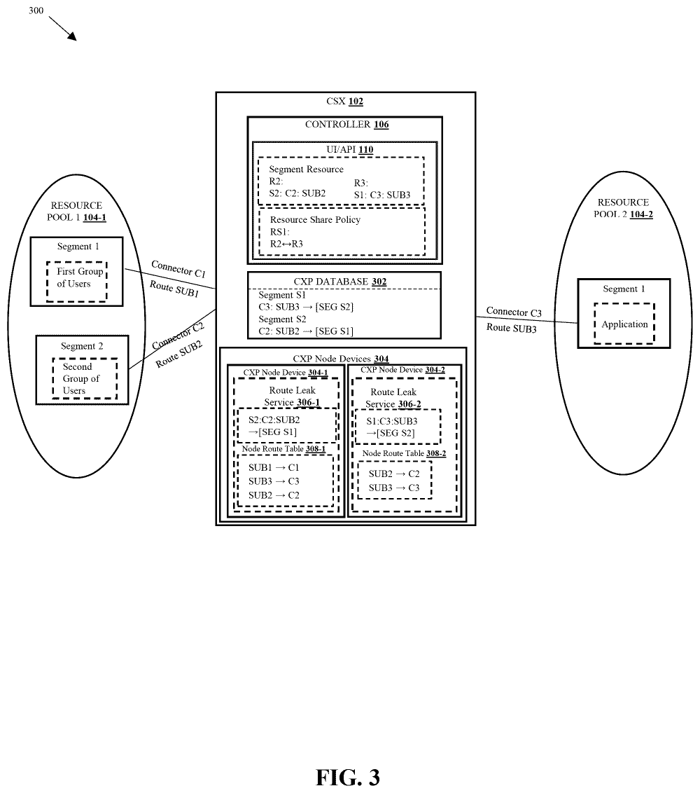

The controller 106 of the CSX 102 implements API and associated backend function for services including resource-share described in detail with reference to description of FIG. 3. The API defines top level abstractions to achieve bidirectional communication between entities involved in the access of a shared resource. The entities may include cloud workloads such as, for example, indicated by the resource pool 104-1. The shared resource may include cloud workloads such as, for example, the resource pool 104-2.

The controller 106 of the CSX 102 is intended to represent a computer system or network of computer systems. A “computer system,” as used herein, may include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

Memory of a computer system includes, by way of example but not limitation, random access memory (RAM), such as dynamic RAM (DRAM) and static RAM (SRAM). The memory can be local, remote, or distributed. Non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. During execution of software, some of this data is often written, by a direct memory access process, into memory by way of a bus coupled to non-volatile storage. Non-volatile storage can be local, remote, or distributed, but is optional because systems can be created with all applicable data available in memory.

Software in a computer system is typically stored in non-volatile storage. Indeed, for large programs, it may not even be possible to store the entire program in memory. For software to run, if necessary, it is moved to a computer-readable location appropriate for processing, and for illustrative purposes in this paper, that location is referred to as memory. Even when software is moved to memory for execution, a processor will typically make use of hardware registers to store values associated with the software, and a local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows from Microsoft Corporation of Redmond, Wash, and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus of a computer system can couple a processor to an interface. Interfaces facilitate the coupling of devices and computer systems. Interfaces can be for input and/or output (I/O) devices, modems, or networks. I/O devices can include, by way of example but not limitation, a keyboard, a mouse or other pointing device, disk drives, printers, a scanner, and other I/O devices, including a display device. Display devices can include, by way of example but not limitation, a cathode ray tube (CRT), liquid crystal display (LCD), or some other applicable known or convenient display device. Modems can include, by way of example but not limitation, an analog modem, an IDSN modem, a cable modem, and other modems. Network interfaces can include, by way of example but not limitation, a token ring interface, a satellite transmission interface (e.g. “direct PC”), or other network interface for coupling a first computer system to a second computer system. An interface can be considered part of a device or computer system.

Computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes at least two components: 1) a dedicated or shared processor or a portion thereof; 2) hardware, firmware, and/or software modules executed by the processor. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized, or its functionality distributed. An engine can include hardware, firmware, or software embodied in a computer-readable medium for execution by the processor. The processor transforms data into new data using implemented data structures and methods, such as is described with reference to the figures in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices. In other embodiments, the engines may be processors executing the applications and/or functionalities.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

Assuming a CRM includes a network, the network can be an applicable communications network, such as the Internet or an infrastructure network. The term “Internet” as used in this paper refers to a network of networks that use certain protocols, such as the TCP/IP protocol, and possibly other protocols, such as the hypertext transfer protocol (HTTP) for hypertext markup language (HTML) documents that make up the World Wide Web (“the web”). More generally, a network can include, for example, a wide area network (WAN), metropolitan area network (MAN), campus area network (CAN), or local area network (LAN), but the network could at least theoretically be of an applicable size or characterized in some other fashion (e.g., personal area network (PAN) or home area network (HAN), to name a couple of alternatives). Networks can include enterprise private networks and virtual private networks (collectively, private networks). As the name suggests, private networks are under the control of a single entity. Private networks can include a head office and optional regional offices (collectively, offices). Many offices enable remote users to connect to the private network offices via some other network, such as the Internet.

The UI/API 110, as implemented by the controller 106, may act as a user interface (UI) and/or as an application programming interface (API). The UI/API 110 may receive from a user a request to provision routes between two or more cloud workloads within the segment or across the segments. The segments may be isolated from each other, thus preventing intersegment communication and access. As per an exemplary network policy, users or cloud workloads hosted in segment 2 of the resource pool 104-1 may not be able to access cloud resources or cloud workloads hosted by segment 1. In this exemplary situation, if it is desired to enable cloud workloads of segment 2 to access one or more cloud resources hosted by segment 1, the user provides an input via the UI of the UI/API 110 to provision route leakage between the segment 1 and the segment 2. The user may also provide a specific set of connectors and a specific set of subnets/routes connected to the segments 1 and 2 in order to provision route leakage from a set of specific cloud workloads hosted by segment 2 to a specific cloud resource hosted by segment 1.

The API of the UI/API 110 defines top level abstractions to achieve bidirectional communication between entities involved in the access of a shared resource, such as but not limited to, the application of the resource pool 104-2. The entities are defined by “segment resources”. A segment resource is a collection of connectors and their associated routes/subnets that are to be leaked into another segment for purposes of achieving the shared access. Once segment resources have been defined a “segment resource share” is defined to bind together the segment resources that need to communicate across the segment boundary. The segment resource share binds together the entities involved in a resource-share and allows for inline application of firewall/security policies.

In some embodiments, the controller 106 includes a user interface (UI) or application programming interface (API) such as the UI/API 110 that enables a user or external application to define or modify a segment resource-share policy. The controller 106 receives user or application inputs via the UI/API 110, which specify the segment resources, route leakage direction, and associated subnets or routes. These inputs are processed by the controller 106 to generate the corresponding segment resource-share policy.

The UI may be a graphical web interface or command-line utility, while the API may be RESTful or RPC-based, and supports submission of policy definitions in structured formats such as JSON or YAML. Upon receiving input, the controller validates, compiles, and stores the generated policy in a CXP database accessible to network nodes.

In an example embodiment, all remote locations connect to their closest cloud exchange point, leveraging a variety of on-premises connectors, such as IPSec VPN, SD-WAN, or private cloud cross-connect, for example and not limited to, AWS direct connect or Azure express route.

The CXP 108 is intended to represent a system that establishes connectivity, instantiates services for corresponding geolocations, aggregates data, implements policies, monitors traffic, and/or provide analytics across disparate cloud service providers and different connectivity architectures such as, but not limited to, resource pools 104-1 and 104-2. In a specific implementation, the CXP 108 operates in a manner that—to the customer—is connectivity agnostic and cloud provider agnostic. The CXP 108 may correspond to aggregated services offered for a given region or set of regions, where the regions may comprise one or more zones corresponding to subsections of such regions. The CXP 108 may service a branch network within a particular region, and multiple CXPs may be stitched together as part of a larger cloud servicing network (e.g., mesh network, hub-and-spoke network, or a network having some other topology) to span multiple regions. In a specific implementation, the CXP 108 provides a portal through which a network administrator or other user associated with a customer may (i) view and select SaaS/IaaS/other services from a range of providers (or provided by the customer itself) within a common dashboard, (ii) manage connectivity (e.g., MLPS, SD-WAN, IPsec, etc.), (iii) monitor traffic, (iv) control traffic in accordance with one or more policies (e.g., security policies), etc. In a specific example, CXPs are deployed in different availability zones for redundancy. All the connections from users, branches and workloads will be multihomed to CXP in each availability zone.

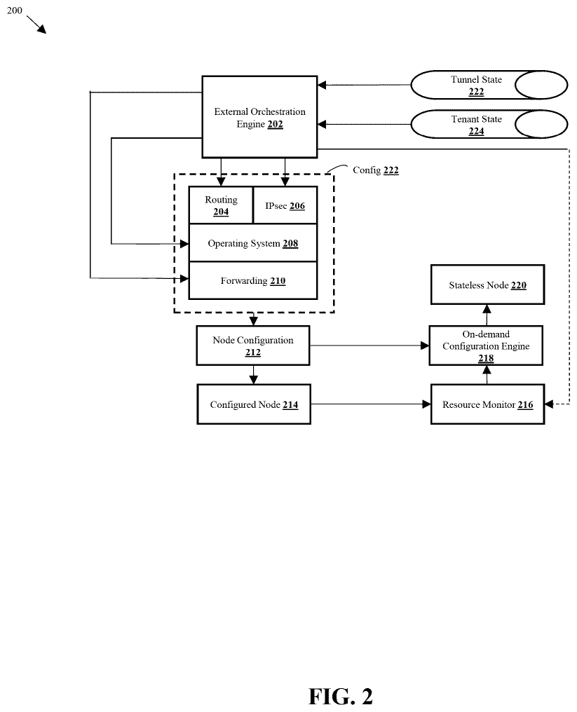

The CXP 108 may include, in addition to other critical components, a routing component and a forwarding component as described in further detail with reference to description of FIG. 2. The forwarding and routing components hold a routing and forwarding table 112 to keep a record of routes or rules that determine where the network traffic from a set of subnets of different segments are directed. The routing and forwarding table is also responsible for storing the next hop of each network and identifying a frame type.

Using the segment resource share or resource share policy being defined by the UI/API 110, the CXP 108 programmatically injects the resource share policy into a route table to leak a route between the segment 1 and the segment 2.

According to an example scenario explained with reference to FIG. 1A, resource pool 104-1 is divided is divided into two segments, for example, a segment 1 with a first group of users and a segment 2 with a second group of users such that the segment 1 is isolated from segment 2 in a way that each of the segments enable ubiquitous communication within the segments if allowed by the network policies but explicitly restricts any communication between segments. This segmentation of user groups is beneficial in networks for security and other business purposes but there are some use cases where it is desired to enable restricted communication between the segments. As an example, and not limited to only this use case, a cloud resource is hosted by segment 1 as indicated by resource pool 104-2. Examples of such a cloud resource may be, but not limited to, mail servers, cloud storage locations, or virtual machines. Another example of such a cloud resource hosted by the segment 1 in the resource pool 104-2 may be a SaaS application, hereinafter referred as an application. As a network policy considered in the exemplary scenario, only users of segment 1 are able to access or share the application hosted in segment 1 and users of segment 1 are not allowed to access the application hosted in segment 1 as indicated by the resource pool 104-2.

Taking the example use-case in FIG. 1A, connector C1 onboards connectivity in the forms of subnets/routes (SUB1) for the first group of users in the segment S1 and connector C3 onboards connectivity in the forms of subnets/routes (SUB3) for the application hosted in the segment 1. As a general example and not only limited to the example illustrated in FIG. 1A, SUB→C indicates how the route for SUB (network) is defined in routing, for example, connector C is the next hop to which packets are forwarded for destinations in the SUB (network). Thus, traffic destined to SUB (network) will be forwarded out of connector C as next hop. Similarly, connector C2 onboards connectivity in the forms of subnets/routes (SUB2) for the second group of users in segment S2. By virtue of being in the same segment, users in the segment 1 are able to access the application via C3. FIG. 1A depicts the routing and forwarding tables 112 for this exemplary scenario, and since there is no route for SUB2 in segment S1 and no route for SUB3 in segment S2, the second group of users cannot communicate with the application hosted in segment 1.

The objective of the instant disclosure is to achieve route leaks in the respective segments i.e. SUB2 is leaked into segment S1 and SUB3 is leaked into segment S2 in order to make access to shared service possible as depicted by FIG. 1B.

FIG. 1B is a diagram 100B of an example of a cloud services exchange (CSX) where specific routes are leaked between isolated segments to enable shared access of the application hosted by one of the segments. The instant invention achieves its objective of route leaks between isolated segments by using the segment resource share or resource share policy defined by the UI/API 110, and programmatically injecting the resource share policy into the routing and forwarding table 112 to leak a route between the segment 1 and the segment 2. As indicated by FIGS. 1A and 1B, the routing and forwarding table 112 is updated to routing and forwarding table 114 by injecting a route SUB2→C2 in segment 1 and a route SUB3→C3 in segment 2. FIG. 1B depicts the routing and forwarding tables 114 for this exemplary scenario, and since there is a route for SUB2 in segment S1 and a route for SUB3 in segment S2, the second group of users can communicate with the application hosted in segment 1. The routing and forwarding tables 114 may also be interpreted to indicate that since SUB1 is not a part of the resource share policy, it is not leaked into segment S2, and hence SUB1 and SUB2 are not interconnected. With reference to the example scenario described with reference to FIG. 1B, it may be noted that SUB1 and SUB2 are not interconnected entirely and only a route SUB2→C2 is leaked into segment S1 (from segment S2) and a route SUB3→C3 is leaked into segment 2 (from segment S1) to enable communication between specific connectors of segment S1 and S2.

Connectors, for example C1, C2, and C3, may include cloud networks, cloud workloads, or cloud connectors, for example but not limited to, AWS virtual private cloud (VPC), Azure virtual networks, Google cloud platform VPC networks, and on-premise and remote access connectors such as IPSec VPN, SD-WAN, or private cloud cross-connect, or remote-access.

FIG. 2 is a diagram 200 of an example of a CXP node configuration system. The diagram 200 includes an external orchestration engine 202, a routing component 204 coupled to the external orchestration engine 202, an IPsec component 206 coupled to the external orchestration engine 202, an operating system (OS) component 208 coupled to the external orchestration engine 202, and a forwarding component 210 coupled to the external orchestration engine 202. The routing component 204, the IPsec component 206, the OS component 208, and the forwarding component 210 can be collectively referred to as a configuration data structure 222.

The diagram 200 further includes a node configuration datastore 212 coupled to the configuration data structure 222, which represents a communication medium from the external orchestration engine 202 over which the configuration data structure is provided for storage in the node configuration datastore 212, a configured node 214 coupled to the node configuration datastore 214, a resource monitor 216 coupled to the configured node 214, an on-demand configuration engine 218 coupled to the resource monitor 216 and the node configuration datastore 212, a stateless node 220 coupled to the on-demand configuration engine 218, a tunnel state datastore 222 coupled to the external orchestration engine 202, and a tenant state datastore 224 coupled to the external orchestration engine 202.

The external orchestration engine 202 is intended to represent an engine that knows tunnel state (represented by the tunnel state datastore 222), which tenant is on which node (represented by the tenant state datastore 224), and how to configure nodes. The term “external” in this context is intended to mean node-external or router-external, as in the external orchestration engine 202 is implemented outside of a router. In a specific implementation, node configuration is performed outside of nodes of a CXP, such as nodes of the CXP 108 of FIG. 1. Advantageously, a node of a CXP can be ripped and replaced due to node configuration being stored outside of the node to be replaced. It may be noted that, with this implementation, it is not necessary for redundant nodes to synch with each other, which is beneficial because redundant nodes have a cost (e.g., synch modules); node-to-node synch communication is at least ameliorated and at best eliminated using the techniques described in this paper.

The routing component 204 is intended to represent a software component implemented on a configured node, such as the configured node 214. Routing forms virtual routing and forwarding (VRF) context for a tenant.

The IPsec component 206 is intended to represent a software component implemented on a configured node, such as the configured node 214. IPsec is a secure network protocol suite that authenticates and encrypts the packets of data to provide secure encrypted communication between two computers over an Internet Protocol network. IPsec includes protocols for establishing mutual authentication between agents at the beginning of a session and negotiation of cryptographic keys to use during the session. In a specific implementation, the IPsec component 206 is compliant with strongSwan, a multiplatform IPsec implementation.

The OS component 208 is intended to represent a software component implemented on a configured node, such as the configured node 214. In a specific implementation, the OS component 208 is compliant with Linux.

The forwarding component 210 is intended to represent a software component implemented on a configured node, such as the configured node 214. Forwarding includes flow management enabling flow-based routing. In a specific implementation, the forwarding component 210 is compliant with vector packet processing (VPP), a software algorithm that is used to quickly process network packets.

The node configuration datastore 212 is intended to represent a datastore of configuration parameters for a node. In a specific implementation, the node configuration datastore is an etcd datastore, etcd is a strongly consistent, distributed key-value store that provides a reliable way to store data that needs to be accessed by a distributed system or cluster of machines. In a specific implementation, the provisioning of nodes is accomplished using an entity relationship diagram (ERD) tool.

The configured node 214 is intended to represent a B-node, such as the B-node 104 of FIG. 1, an S-node, such as one of the S-nodes 108 of FIG. 1, or a V-node, such as the V-node 110 of FIG. 1. In a specific implementation, within the configured node 214 are configuration parameters such as represented in the diagram 200 as config data structure 222 (i.e., the routing component 204, the IPsec component 206, the OS component 208, and the forwarding component 210). Although the configured node 214 is coupled to the node configuration datastore 212 and, at least by implication, received configuration parameter values from the node configuration datastore 212, it should be understood that, instead or in addition, the configured node 214 could be pre-configured (i.e., at least partially configured prior to being coupled to the node configuration datastore 212).

The resource monitor 216 is intended to represent an engine that sends a trigger to the on-demand configuration engine 218 responsive to a stimulus from the configured node 214. Instead or in addition, the stimulus could come from some other source, such as the external orchestration engine 202, which is represented in the diagram 200 as a dotted arrow from the external orchestration engine 202 to the resource monitor 216. The stimulus is indicative of a need to spin up additional nodes to handle network resource consumption.

The on-demand configuration engine 218 is intended to represent an engine that provides node configuration parameter values to the stateless node 220 in response to a trigger from the resource monitor. In a specific implementation, the trigger is an indication that additional nodes are needed to handle network resource consumption. If network resource consumption decreases, the stimulus from the configured node 214 to the resource monitor 216 could also trigger the on-demand configuration engine 218 to tear down nodes (not shown).

The stateless node 220 is intended to represent a node that is not initially employed to handle network resource demands (e.g., traffic). Upon obtaining configuration parameter values from the node configuration datastore 212 via the on-demand configuration engine 218, where the configured node 214 is a first configured node, the stateless node 220 becomes a second configured node. In an alternative, the stateless node 220 could initially be handling network resource demands but its configuration is changed by the on-demand configuration engine 218 upon receipt of a trigger at the on-demand configuration engine 218 from the resource monitor 216.

FIG. 3 is a diagram 300 illustrating route leak provisioning in a CSX, in accordance with an embodiment of the disclosure. The diagram 300 includes the CSX 102, the resource pool 104-1, and the resource pool 104-2. In the diagram 300, the CSX 102 includes at least a controller 106 and a cloud exchange point (CXP) 108. In the diagram 300, the CSX 102 includes the controller 106, a CXP database 302 and CXP node devices 304. FIG. 2 is explained in conjunction with elements from FIGS. 1A, 1B, and 2. For example, details of the resource pool 104-1, the resource pool 104-2, the controller 106 and the CXP node devices 304 of the CSX 102 may be found in the description of FIGS. 1A, 1B, and 2.

The UI/API 110 of the controller 106 includes one or both of a user interface (UI) and an application programming interface (API). The UI may be a keyboard, a monitor, a touch screen, audio, video, or facial recognition, provided in any suitable device such as a dedicated display/computing mobile device, could be used to input information regarding network provisioning or route leaking between segments. The API is provided so that application developers can create application software that uses the standard or dedicated interface commands to request and set up routes. The API defines top level abstractions to achieve bidirectional communication between entities involved in the access of a shared resource, for example, application hosted by segment 1 in the resource pool 104-2 as indicated by FIG. 3. The entities are defined by “segment resources”. The “segment resource-share” binds together the entities involved in a resource-share and allows for inline application of firewall/security policies.

The CXP database 302 may be, for example, a read-only memory (ROM), a flash memory, dynamic random-access memory (DRAM) such as synchronous DRAM (SDRAM) or Rambus DRAM (RDRAM), or a static memory (e.g., flash memory, static random-access memory (SRAM), etc.), which communicate with the controller 106 and the CXP node devices 304. The CXP database 302 may be implemented as a cloud storage hosted on cloud resources accessible to both the controller 106 and the CXP node devices 304. In a specific implementation, the CXP database 302 stores the resource share policy generated by the UI/API 110 and allows the CXP node devices 304 to access the stored resource share policy.

FIG. 3 illustrates a system to manage a plurality of cloud workloads hosted by a plurality of cloud segments isolated from each other. The CSX 102 may be an example of this system. As an example, as illustrated by FIG. 3, the plurality of cloud workloads may be entities hosted in segment 1 and segment 2, and categorized as belonging to the resource pool 104-1 and the resource pool 104-2. The resource pool 104-1 may include cloud workloads hosted by both segment 1 and segment 2. The resource pool 104-2 may include cloud workloads hosted by segment 1 only. An example of the cloud workload in the resource pool 104-2 may be a SaaS application, hereinafter referred as an application. In a specific implementation to achieve security in network and business purposes, segment 1 and segment 2 are isolated such that each of the segments enable ubiquitous communication within the segments if allowed by the network policies but explicitly restricts any communication between segments. For a specific use case, the users of segment 2 needs access to the application hosted in segment 1.

To implement the use case where the users of segment 2 (or cloud workloads hosted in segment 2) need access to the application (or the cloud resource) hosted in the segment 1, an input may be provided via the UI of the UI/API 110 to permit the users of the segment 1 to access the application hosted in the segment 2 which is isolated from the segment 1.

The API of the UI/API 110 may define one or more sets of segment resources. A first set of segment resources R2 in segment 2 is defined to include at least one of first connectors C2 or a first set of subnets or routes SUB 2 associated with the cloud segment 2. A second set of segment resources R3 in segment 1 is defined to include at least one of second connectors C3 or a second set of subnets or routes SUB3 associated with the application (or cloud resource) hosted in segment 1. A segment resource is a collection of connectors and their associated routes/subnets that are to be leaked into another segment for purposes of achieving the shared access. With reference to the example illustrated in FIG. 3, connector C1 onboards connectivity in the forms of subnets/routes SUB1 for a set of remote-users in segment S1 and connector C3 onboards connectivity in the forms of subnets/routes SUB3 for the application (such as an email server application). Similarly, connector C2 onboards connectivity in the forms of subnets/routes SUB2 for a set of remote-users in segment S2. In an exemplary embodiment, segments resources may be defined as below:

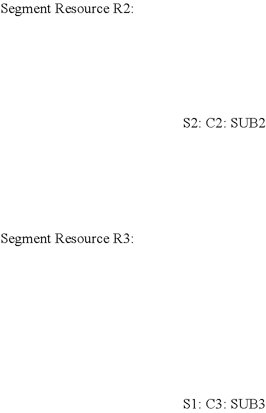

The UI/API 110 of the controller 106 now defines a resource share policy using the one or more sets of segment resources. A resource share policy exists in terms of users defining it. Whatever resources that need to communicate with each other, a resource share policy is defined for it. Users define the resource as set of routes associated with the particular entity that need to communicate. Once the segment resources (for example, R2 and R3) have been defined, a segment resource share policy is defined to bind together segment resources that need to communicate across the segment boundary. An inline firewall policy may also be specified. For the example illustrated in FIG. 3, a segment resource share policy (or a “resource-share”) RS1 may now be specified associating the segment resource R2 with the segment resource R3. The resource share policy defines the leakage of the second set of subnets or routes SUB3 from the second connectors C3 of the application hosted in the cloud segment 1 to the cloud segment 2, and the leakage of the first set of subnets or routes SUB 2 from the first connectors C2 of the cloud segment 2 to the cloud segment 1. For the route that is leaked into a segment, forwarding happens using a segment lookup in context of the leaked segment for the leaked route. In an exemplary embodiment, the resource share policy or resource-share may be defined as below:

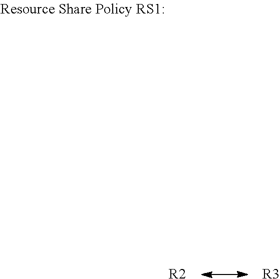

The communication between the segment resources R2 and R3 may be unidirectional or bidirectional. As an exemplary illustration, R2↔R3 indicates bidirectional communication between resources R2 and R3, and R2→R3 indicates unidirectional communication between resources R2 and R3.

The controller 106 stores the resource share policy defined to perform route leaking into the CXP database 302. The CXP database 302 stores this definition as a policy of resource share. The CXP database 302 stores the abstraction as defined by the UI/API 110. In an embodiment, the CXP database 302 stores the resource share policy as constructs acceptable to CXP nodes 304. An example of the resource share policy being stored in the CXP database 302 is defined below:

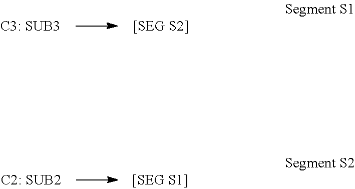

In an embodiment, the controller 106 breaks down the resource share policy at a per connector level and write to the CXP database 302 using a producer consumer model based on event notifications. In an example embodiment, producer refers to source of the data in the database and writes data to the database. In this example use case illustrated in FIGS. 1A, 1B, and 3, the producer is the controller 106 which writes the resource-share policy into the CXP database 302. Consumer refers to the service/component that reads the data thus written by registering for writes/changes to the CXP database 302. On being notified of a change or new update, consumer service processes the change appropriately. In this example use case illustrated in FIGS. 1A, 1B, and 3, the consumer of the database update is the node route-leak service that injects the route appropriately on receiving a new update for the same.

The controller 106 writes the policy at a connector level onto the CXP database 302. Using the above example, the following policy is programmed in the CXP database:

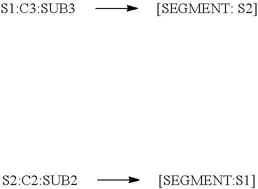

S1:C3:SUB3→ [SEGMENT: S2] indicates that the set of subnets from connector C3 in segment S1 are leaked into segment S2.
S2:C2:SUB2→ [SEGMENT: S1] indicates that the set of subnets from connector C2 in segment S2 are leaked into segment S1.

According to the example scenario described with reference to FIG. 3, the controller 106 fragments the resource share policy into a plurality of policy fragments by defining a separate policy fragment of the resource share policy for each connector of the first set of connectors C2 and the second set of connectors C3, and storing the defined resource share policy in the CXP database 302.

Once the newly defined resource share policy is published to CXP database 302, the CXP nodes 304 in the network of CXP architecture listens to newly defined resource share policy or updates to the existing policies and consumes these policies to define routing and forwarding rules.

In another embodiment and according to the example scenario described with reference to FIG. 3, the controller 106 may distribute the resource share policy from the CXP database 302 to a set of routing nodes 304-1 and 304-2 in the system including CXP architecture. In an embodiment, each routing node or the CXP nodes 304 hosts a node service.

In an embodiment, the node service is also referred to as “route leak service”. The node service may be a micro service residing on every node, the function of which is to extract the routes, running route-leak/resource-share policy, and injecting shared/leaked routes into the leaked segments.

Once resource-share policy is consumed by the node services on each of the CXP nodes 304, the node service now extracts routes from a border gateway protocol (BGP) table, runs the per connector resource-share policy on the routes to determine which routes needs to be leaked to different segments as per the resource share policy. The routes are then injected into the target segments by serializing the routes using protobufs, which are then decoded and processed on a network BGP stack as per the format of the protobuf messages. The route injection happens at the source of routes, that is the on CXP nodes 304 that onboard the connector, instead of at the destination as is the case which traditional methods. Since the source nodes are typically are fewer in number, the proposed method scales better since all nodes do not have to be configured with the resource policy (or route-leak policy) once the source nodes need to ingest the policy to perform the route-leak. Protobuf is like a microservice that sits on a node and serializes the resource share policy and injects it into the routing table on the network stack. The route-leak (injection of the route into the leaked segment) happens on the CXP node where the connector is hosted, instead of it being performed on the other CXP nodes in the network to which the route is sent. Thus, the route-leak policy does not need to be replicated on all the nodes in the network. Instead, it just needs to be present on the source CXP node as above.

According to the example scenario described with reference to FIG. 3, the CXP architecture may include a CXP node 304-1 and a CXP node 304-2 as the CXP nodes 304. A person skilled in the art would appreciate that more such CXP nodes may exist in the CXP architecture to enable route leak between isolated segments. The node service residing on the CXP nodes 304-1 and 304-2 may include route leak services 306-1 and 306-2 respectively.

According to the example scenario described with reference to FIG. 3, below steps are performed by each of the route leak services 306-1 or 306-2 to implement the resource share policy (S1:C3:SUB3→ [SEGMENT: S2] and S2:C2:SUB2→ [SEGMENT: S1]) as listened by the corresponding CXP node 304-1 or 304-2.
Step 1. Extract a route table from the BGP stack.
Step 2. Run the resource share policy to determine that segment S1 route from connector C3 and the routes/subnets SUB3 need to be leaked into S2.
Step 3. Identify the routes/subnets SUB3.
Step 4. Serialize the routes/subnets SUB3 into protobuf messages along with attributes carried over from the routes in the segment S1 for encoding into the segment S2. This step generates protobuf messages as below:
   [Target Segment: S2 [Route: SUB3 Attributes:[ ]]
Step 5. Inject the generated protobuf message into the network BGP stack.

After receiving the protobuf message, the network BGP stack decodes the protobuf message and injects the route into the BGP table which is then sent to the rest of the nodes in the network without any additional configuration.

According to the example scenario described with reference to FIG. 3, each of the CXP nodes 304-1 or 304-2 enforces, using the corresponding route leak service 306-1 or 306-2, the resource share policy onto a corresponding node route table 308-1 or 308-2 to leak a route between the segment S2 and the segment S1.

The injected route in the destination segment S2 also now points to a virtual interface for purposes of performing a lookup in the source segment S1 to forward the packet using the route in the source segment. In this way, the route leaks in the respective segments (SUB2 leaked into S1 and SUB3 leaked into S2) is achieved to make access to shared service possible. The next hop of a leaked route points to a virtual interface that induces the cross-segment route lookup in the original (source) segment, in order for the packet to be forwarded out of the connector interface of the lookup in the source segment. This is how the cross-segment forwarding is accomplished in order to realize the forwarding function for the leaked routes.

In another embodiment, granular security policy may be implemented for network flows to be re-directed to a firewall for implementation of any security policy. The network flows or traffic related to the resource-share or resource share policy may be redirected via a firewall. According to the example scenario illustrated by FIG. 3, the traffic originating from the remote users of segment 2 destined to the application in the segment 1 may now be redirected through a firewall for purposes of security inspection and policy.

In order to achieve the same, routes corresponding to segment resources from both source and destination segments are tagged distinctly to identify them as being associated with the appropriate segment resource. Security policy can then be defined to redirect traffic originating or destined to segment resources via the firewalls which implement security policy for inspection. In order to do this, route lookup in the forwarding is enhanced to implement policy based forwarding as per tags on the route to identify the appropriate segment resources associated with the source and destination of the traffic. Additionally, the resource-share policy is integrated with the firewall such that granular security policy may be defined for traffic associated with a resource share. In particular, the security policy as described in the instant paper includes the application of the firewall policy for cross-segment (inter-segment) traffic which is not possible in other implementation of route leaking. Conventionally, the prior implementation was to support the firewall policy in context of a single segment only.

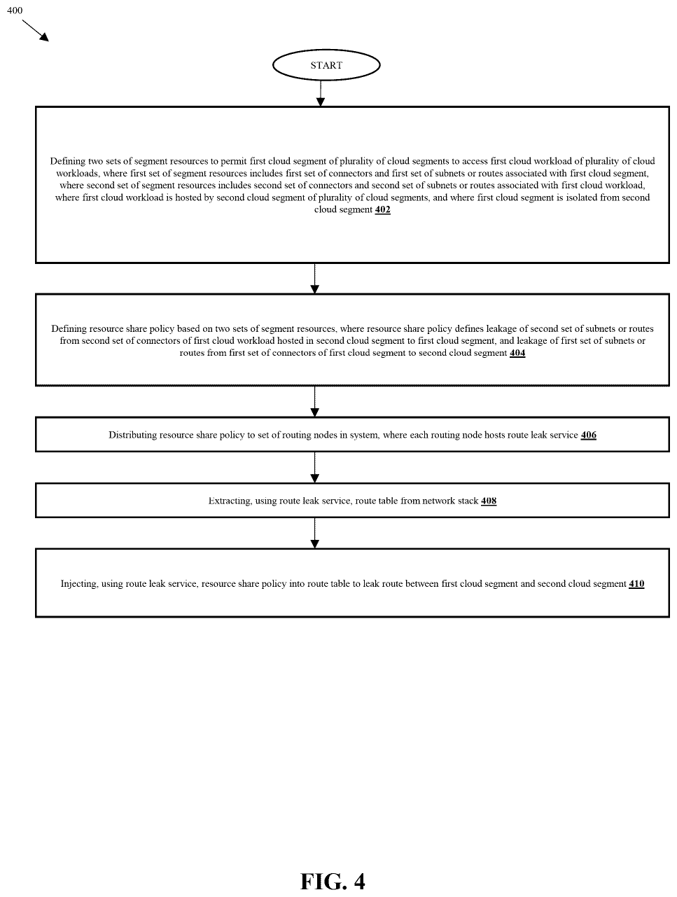

FIG. 4 is a flowchart that illustrates an example of a method for route leak provisioning, in accordance with an embodiment of the disclosure. FIG. 4 is explained in conjunction with elements from FIG. 1A, FIG. 1B, FIG. 2, and FIG. 3. With reference to FIG. 4, there is shown a flowchart 400. The operations from 402 to 410 may be implemented by any computing system, such as, by the CSX 102 of FIGS. 1A, 1B, and 3. The operations may start at 402 and may proceed to 410.

At 402, two sets of segment resources are defined to permit a first cloud segment of the plurality of cloud segments to access a first cloud workload of the plurality of cloud workloads. In at least one embodiment, the controller 106 defines two sets of segment resources to permit a first cloud segment of the plurality of cloud segments to access a first cloud workload of the plurality of cloud workloads. A first set of segment resources includes first set of connectors and a first set of subnets or routes associated with the first cloud segment. A second set of segment resources includes second set of connectors and a second set of subnets or routes associated with the first cloud workload. The first cloud workload is hosted by a second cloud segment of the plurality of cloud segments. The first cloud segment is isolated from the second cloud segment. Alternatively, the computing, at 402 may also receive definitions of a first segment resource associated with the first cloud segment and a second segment resource associated with the second network segment.

At 404, a resource share policy may be defined based on the two sets of segment resources. In at least one embodiment, the controller 106 defines a resource share policy based on the two sets of segment resources. The resource share policy defines the leakage of the second set of subnets or routes from the second set of connectors of the first cloud workload hosted in the second cloud segment to the first cloud segment, and the leakage of the first set of subnets or routes from the first set of connectors of the first cloud segment to the second cloud segment. Alternatively, the computing system, at 406 may generate a segment resource-share policy specifying one or more subnets or routes associated with the first segment resource to be leaked into the second network segment, or one or more subnets or routes associated with the second segment resource to be leaked into the first network segment

At 406, the resource share policy may be distributed to a set of routing nodes in the system. In at least one embodiment, the controller 106 distributes the resource share policy to a set of routing nodes in the system. Each routing node hosts a route leak service. In another embodiment, the controller 106 may notify an update in the resource share policy to a set of routing nodes in the system, and each of the set of routing nodes may consume the notifications sent by the controller 106 to locally cache the policy on the routing nodes.

At 408, a route table may be extracted extracting, using the route leak service, from a network stack. In at least one embodiment, the CXP nodes 304 extracts, using the route leak service, a route table from a network stack.

At 410, the resource share policy may be injected, using the route leak service, into the route table to leak a route between the first cloud segment and the second cloud segment. In at least one embodiment, the CXP nodes 304 injects, using the route leak service, the resource share policy into the route table to leak a route between the first cloud segment and the second cloud segment. Control may pass to the end.

Although the flowchart 400 is illustrated as discrete operations, such as 402, 404, 406, 408, and 410, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (such as the CSX 102). The computer-executable instructions may cause the machine and/or computer to perform operations that include defining two sets of segment resources to permit a first cloud segment of the plurality of cloud segments to access a first cloud workload of the plurality of cloud workloads. A first set of segment resources includes first set of connectors and a first set of subnets or routes associated with the first cloud segment. A second set of segment resources includes second set of connectors and a second set of subnets or routes associated with the first cloud workload. The first cloud workload is hosted by a second cloud segment of the plurality of cloud segments. The first cloud segment is isolated from the second cloud segment. The operations may further include defining a resource share policy based on the two sets of segment resources. The resource share policy defines the leakage of the second set of subnets or routes from the second set of connectors of the first cloud workload hosted in the second cloud segment to the first cloud segment, and the leakage of the first set of subnets or routes from the first set of connectors of the first cloud segment to the second cloud segment. The operations may further include distributing the resource share policy to a set of routing nodes in the system such that each routing node hosts a route leak service. The operations may further include extracting, using the route leak service, a route table from a network stack. The operations may further include injecting, using the route leak service, the resource share policy into the route table to leak a route between the first cloud segment and the second cloud segment.

Exemplary aspects of the disclosure may include a system (such as the CSX 102 of FIG. 1A) that may include circuitry (such as the controller 106 and the CXP node devices 304). The system may include one or more hardware processors. The system may also include a memory storing instructions that, when executed by the one or more hardware processors, cause the system to define two sets of segment resources to permit a first cloud segment of the plurality of cloud segments to access a first cloud workload of the plurality of cloud workloads. A first set of segment resources includes first set of connectors and a first set of subnets or routes associated with the first cloud segment. A second set of segment resources includes second set of connectors and a second set of subnets or routes associated with the first cloud workload. The first cloud workload is hosted by a second cloud segment of the plurality of cloud segments. The first cloud segment is isolated from the second cloud segment. The system may be further configured to define a resource share policy based on the two sets of segment resources. The resource share policy defines the leakage of the second set of subnets or routes from the second set of connectors of the first cloud workload hosted in the second cloud segment to the first cloud segment. The leakage of the first set of subnets or routes from the first set of connectors of the first cloud segment to the second cloud segment. The system may be further configured to distribute the resource share policy to a set of routing nodes in the system such that each routing node hosts a route leak service. The system may be further configured to extract, using the route leak service, a route table from a network stack. The system may be further configured to inject, using the route leak service, the resource share policy into the route table to leak a route between the first cloud segment and the second cloud segment.

In accordance with an embodiment, the system may further include a user interface. The system may be further configured to receive an input via the user interface to permit the first cloud segment to access the first cloud workload.

In accordance with an embodiment, the system may be further configured to fragment the resource share policy into a plurality of policy fragments by defining a separate policy fragment of the resource share policy for each connector of the first set of connectors and the second set of connectors.

In accordance with an embodiment, the system may further include a database. The system may be further configured to store the defined resource share policy in the database.

In accordance with an embodiment, the system may be further configured to redirect traffic flow originating from the first cloud segment destined to the first cloud workload hosted in the second cloud segment through a firewall.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed.

What is claimed is:

1. A system for managing communication between isolated network segments, the system comprising:
one or more hardware processors; and
a memory storing instructions that, when executed by the one or more hardware processors, cause the system to:
receive definitions of a first segment resource associated with a first network segment and a second segment resource associated with a second network segment, wherein each of the first segment resource and the second segment resource comprises one or more connectors and associated subnets or routes, and wherein the first network segment is isolated from the second network segment;
generate a segment resource-share policy specifying one or more subnets or routes associated with the first segment resource to be leaked into the second network segment, or one or more subnets or routes associated with the second segment resource to be leaked into the first network segment; and
store or distribute the segment resource-share policy in a form accessible to one or more network nodes configured to enforce the segment resource-share policy.

2. The system of claim 1, wherein the segment resource-share policy defines a bidirectional route leakage between the first segment resource and the second segment resource.

3. The system of claim 1, wherein the segment resource-share policy defines a unidirectional route leakage from the first segment resource to the second network segment.

4. The system of claim 1, wherein generating the segment resource-share policy comprises generating a separate policy fragment for each connector included in the first segment resource and the second segment resource.

5. The system of claim 1, wherein the segment resource-share policy is stored in a database in a serialized format accessible to the one or more network nodes.

6. The system of claim 1, wherein each network node of the one or more network nodes is configured to extract routing information from a routing protocol stack and apply the segment resource-share policy to inject the one or more subnets or routes associated with the first segment resource into a routing table associated with the second network segment, or the one or more subnets or routes associated with the second segment resource into a routing table associated with the first network segment.

7. The system of claim 1, wherein the instructions stored in the memory further cause the system to tag one or more routes defined by the segment resource-share policy for policy-based forwarding or redirection.

8. The system of claim 7, wherein the one or more routes defined by the segment resource-share policy are redirected through a firewall for application of a security policy.

9. The system of claim 1, wherein the instructions stored in the memory further cause the system to:
receive, via a user interface or application programming interface, input from a user or application defining the segment resource-share policy; and
generate the segment resource-share policy based on the received input.

10. The system of claim 1, wherein
the system further comprises a user interface, and
the instructions stored in the memory further cause the system to receive an input via the user interface to permit the first network segment to access a cloud workload in the second network segment.

11. The system of claim 1, wherein the instructions stored in the memory further cause the system to redirect traffic flow originating from the first network segment destined to a cloud workload hosted in the second network segment through a firewall.

12. A method for managing communication between isolated network segments, the method comprising:
receiving definitions of a first segment resource associated with a first network segment and a second segment resource associated with a second network segment, wherein each of the first segment resource and the second segment resource comprises one or more connectors and associated subnets or routes, and wherein the first network segment is isolated from the second network segment;
generating a segment resource-share policy specifying one or more subnets or routes associated with the first segment resource to be leaked into the second network segment, or one or more subnets or routes associated with the second segment resource to be leaked into the first network segment; and
storing or distributing the segment resource-share policy in a form accessible to one or more network nodes configured to enforce the segment resource-share policy.

13. The method of claim 1, wherein the segment resource-share policy defines a bidirectional route leakage between the first segment resource and the second segment resource.

14. The method of claim 1, wherein the segment resource-share policy defines a unidirectional route leakage from the first segment resource to the second network segment.

15. The method of claim 1, wherein generating the segment resource-share policy comprises generating a separate policy fragment for each connector included in the first segment resource and the second segment resource.

16. The method of claim 1, wherein the segment resource-share policy is stored in a database in a serialized format accessible to the one or more network nodes.

17. The method of claim 1, wherein each network node of the one or more network nodes is configured to extract routing information from a routing protocol stack and apply the segment resource-share policy to inject the one or more subnets or routes associated with the first segment resource into a routing table associated with the second network segment, or the one or more subnets or routes associated with the second segment resource into a routing table associated with the first network segment.

18. The method of claim 1, further comprising tagging one or more routes defined by the segment resource-share policy for policy-based forwarding or redirection.

19. The method of claim 18, wherein the one or more routes defined by the segment resource-share policy are redirected through a firewall for application of a security policy.

20. A non-transitory computer-readable medium having stored thereon computer-executable instructions, which when executed by one or more processors, cause the one or more processors to execute operations comprising:
receiving definitions of a first segment resource associated with a first network segment and a second segment resource associated with a second network segment, wherein each of the first segment resource and the second segment resource comprises one or more connectors and associated subnets or routes, and wherein the first network segment is isolated from the second network segment;
generating a segment resource-share policy specifying one or more subnets or routes associated with the first segment resource to be leaked into the second network segment, or one or more subnets or routes associated with the second segment resource to be leaked into the first network segment; and
storing or distributing the segment resource-share policy in a form accessible to one or more network nodes configured to enforce the segment resource-share policy.
